(19) United States
(12) Patent Application Publication
(10) Pub. No.: US 2002/0081183 A1
(43) Pub. Date: Jun. 27, 2002

(54) Belly dump vehicle

(76) Inventor: Mike E. Wilson, Leduc (CA)

Correspondence Address: DAVIS & BUJOLD, P.L.L.C., 500 NORTH COMMERCIAL STREET, FOURTH FLOOR, MANCHESTER, NH, 03101, US

(21) Appl. No.: 10/035,899

(22) Filed: Dec. 26, 2001

(30) Foreign Application Priority Data
Dec. 27, 2000 (CA) 2,329,643

(51) Int. Cl. B60P 1/00

(52) U.S. Cl. 414/526; 414/519; 414/502

(57) ABSTRACT

A belly dump vehicle includes a containment body with an exterior surface and an underlying belly having opposed ends. An auger tunnel extends through one of the opposed ends of the belly and communicates with the exterior surface of the body. A rotatably mounted auger extends between the opposed ends of the belly and protrudes into the auger tunnel. A granular matter broadcast assembly is mounted to the exterior of the body in communication with the auger tunnel. A prime mover selectively rotates the auger, whereby granular matter from a load contained in the belly is fed by the auger through the auger tunnel to the broadcast assembly.

### FIELD OF THE INVENTION

The present invention relates to a belly dump vehicle

### BACKGROUND OF THE INVENTION

A belly dump vehicle is a truck or trailer having a body with underlying doors which are moveable from a closed position to an open position to dump a load.

Tnstead of dumping the entire load at one location, it is sometimes preferable to broadcast the load over a wide area. At the present time a belly dump vehicle is incapable of broadcasting the load.

SUMMARY OF THE INVENTION

What is required is a belly dump vehicle which is capable of either dumping the entire load at one location or broadcasting the load over a wide area.

According to the present invention there is provided a belly dump vehicle which includes a containment body with an exterior surface and an underlying belly having opposed ends. Ground engaging support wheels are provided for supporting the body which are spaced from the belly. Doors are provided in the underlying belly which are moveable from a closed position to an open position. A first prime mover moves the doors from the closed position to the open position whereby a load of granular matter contained within the belly is dumped. An auger tunnel extends through one of the opposed ends of the belly and communicates with the exterior surface of the body. A rotatably mounted auger extends between the opposed ends of the belly and protrudes into the auger tunnel. A granular matter broadcast assembly is mounted to the exterior of the body in communication with the auger tunnel. A second prime mover selectively rotates the auger, whereby granular matter from a load contained in the belly is fed by the auger through the auger tunnel to the broadcast assembly.

The belly dump vehicle, as described above, is capable of either dumping a load of granular matter or broadcasting the load. It is envisaged that the belly dump vehicle described will be used for broadcasting sand, salt or salt/sand mixtures on roads. It will be appreciated that the belly dump vehicle could be used with fertilizer or other granular matter.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view, in section, of a belly dump vehicle constructed in accordance with the teachings of the present invention.

FIG. 2 is top plan view of the belly dump vehicle illustrated in FIG. 1.

FIG. 3 is an end elevation view, in section, of the belly dump vehicle illustrated in FIG. 1, with doors in the closed position.

FIG. 4 is an end elevation view, in section, of the belly dump vehicle illustrated in FIG. 1, with doors in the open position.

FIG. 5 is a detailed side elevation view of auger illustrated in FIG. 1, with auxilliary break-up shaft.

### DETAILED DESCRIPTION OF THE PREFERRED EMBODIMENT

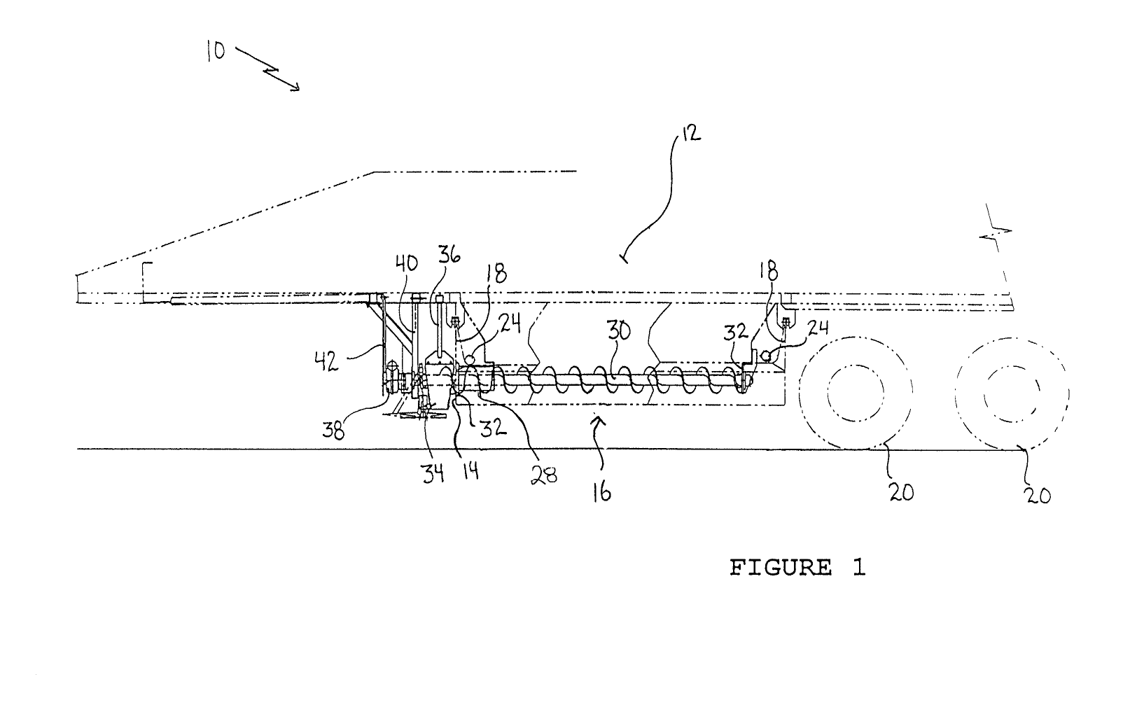

The preferred embodiment, a belly dump vehicle generally identified by reference numeral 10, will now be described with reference to FIGS. 1 through 5.

Structure and Relationship of Parts:

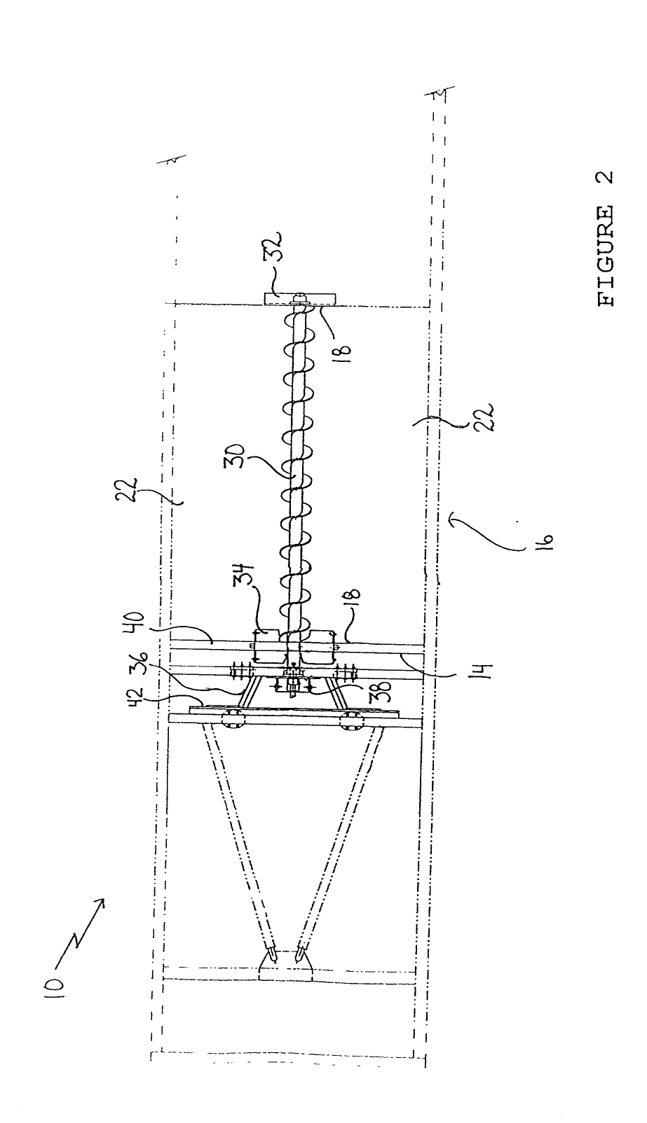

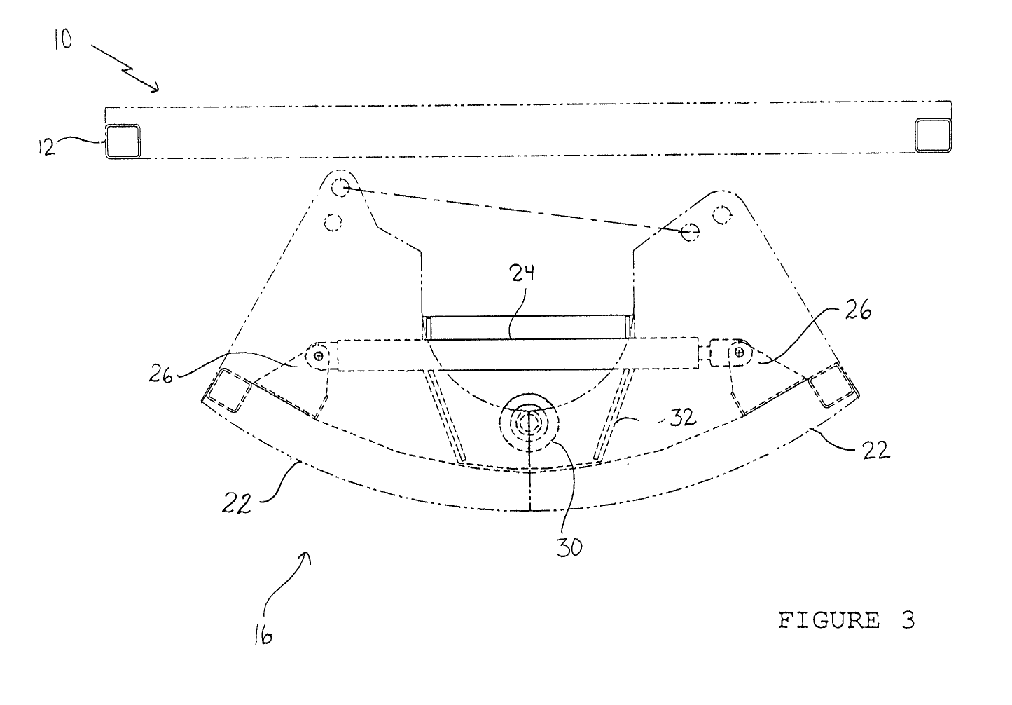

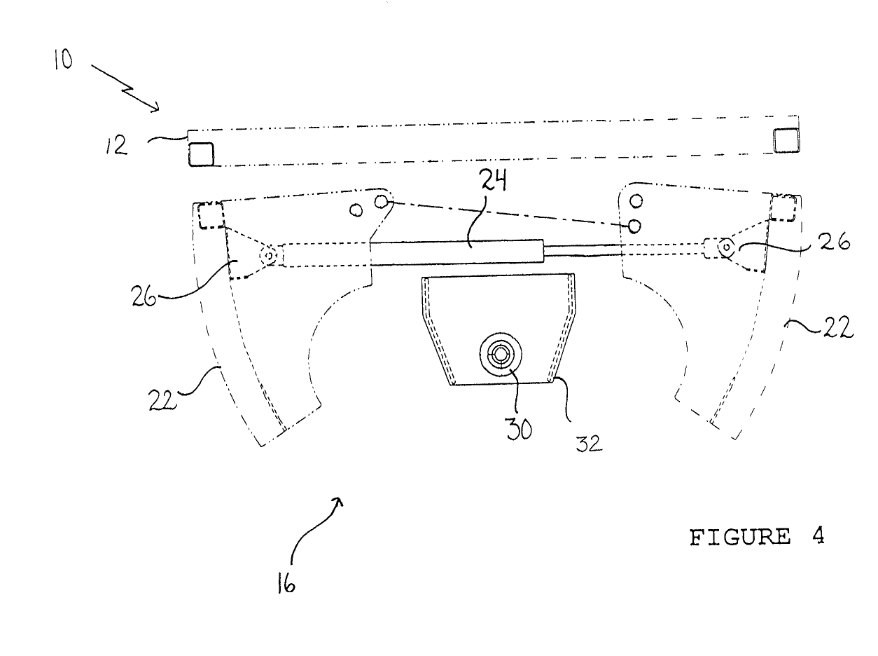

Referring to FIG. 1, there is provided a belly dump vehicle 10 that includes a containment body in the form of a containment box 12 with an exterior surface 14 and an underlying belly 16. Referring to FIG. 2, underlying belly 16 has opposed bulkhead ends 18. Referring to FIG. 1, ground engaging support wheels 20, which support box 12, are spaced from belly 16. Referring to FIG. 3, two clam shell style doors 22 are provided that are pivotally mounted to box 12 for movement from a closed position illustrated in FIG. 3 to an open position as illustrated in FIG. 4. Clam shell doors 22 allow underlying belly 16 of box 12 to be opened up to dump its contents. Referring to FIGS. 3 and 4, a first prime mover in the form of two extendable hydraulic cylinders 24 are provided for moving doors 22 from the closed position to the open position whereby a load of granular matter contained within belly 16 is dumped. Referring to FIG. 1, hydraulic cylinders 24 are positioned at each of opposed ends 18 of belly 16. Referring to FIGS. 3 and 4, hydraulic cylinders 24 are fixed to each door 22 at pivot connections 26. While the first prime mover is illustrated as being hydraulic cylinders, it will be appreciated that other types of prime movers could also be used to move doors 22.

Referring to FIG. 1, an auger tunnel 28 extends through one of opposed ends 18 of belly 16 and communicates with exterior surface 14 of box 12. Referring to FIG. 2, a rotatably mounted auger 30 extends between opposed ends 18 of belly 16 and protrudes into auger tunnel 28. Auger 30 is supported between opposed ends 18 of belly 16 by augur supports 32 positioned at each opposed end 18 of belly 16.

Referring to FIG. 1, a granular matter broadcast assembly 34 is mounted to exterior surface 14 of box 12 by a support member 36. Broadcast assembly 34 is in communication with auger tunnel 28. A second prime mover in the form of a hydraulic motor 38 is provided for selectively rotating auger 30, whereby granular matter from a load contained in belly 16 is fed by auger 30 through auger tunnel 28 to broadcast assembly 34. In the illustrated embodiment, second prime mover is shown as being a hydraulic motor 38 however it will be appreciated that other types of prime movers could also be used to selectively rotate auger 30. Hydraulic motor 38 is also mounted to exterior surface 14 of box 12 by a support member 40. A mud flap 42 hangs down from exterior surface 14 of box 12 proximate to hydraulic motor 38 to protect hydraulic motor 38 and broadcast assembly 34.

Operation:

The use and operation of belly dump vehicle 10 will now be described with reference to FIGS. 1 through 4. Belly dump vehicle 10 is suitable for transporting a load of granular material to one location and dumping it, or for broadcasting a load of granular material such as when sanding or salting winter roads. Referring to FIG. 3, when belly dump vehicle 10 is being prepared to hold a load of granular material, hydraulic cylinders 24 are used to move doors 22 to the closed position. With doors 22 in the closed position, granular material can be loaded into and securely contained within box 12 of belly dump vehicle 22.

Referring to FIG. 4, if belly dump vehicle 10 is to be used to transport its load to another location to dump it, upon arrival at the dumping location, doors 22 of belly dump vehicle 10 are moved by hydraulic cylinders 24 to the open position, thereby allowing the load to exit box 12 of belly dump vehicle 10. Referring to FIG. 1, if belly dump vehicle 10 is to be used to broadcast its load, upon reaching the location where its load is to be broadcast, hydraulic motor 38 is used to selectively rotate auger 30. Auger 30 then continually moves granular material contained within box 12 though auger tunnel 28 to broadcast assembly 34.

Broadcast assembly 34 then broadcasts the granular material as belly dump vehicle 10 moves over a selected area. In the event, there is a need to dump the load from belly dump vehicle 10 in order to dislodge foreign matter, make repairs, inspect auger 30, or to switch the type of load, doors 22 of belly dump vehicle 10 can be moved to the open position and load is dumped while auger 30 remains in place. The ability to use belly dump vehicle 10 either for transporting material and dumping, or for broadcasting it's load gives belly dump vehicle 10 added versatility.

Variations:

Experience has been gained from the operation of several prototypes of belly dump vehicle 10. It was determined that some materials do not flow to feed auger 30 as well as other materials. It was also determined that material that flows to feed auger when dry, sometimes does not provide an acceptable flow to auger 30 when wet. Belly dump vehicle 10 operates best when there is a steady flow of material feeding auger 30. Modifications were, therefore, made to ensure that the flow of material to auger 30 was contant regardless of the type of material and even when in wet conditions.

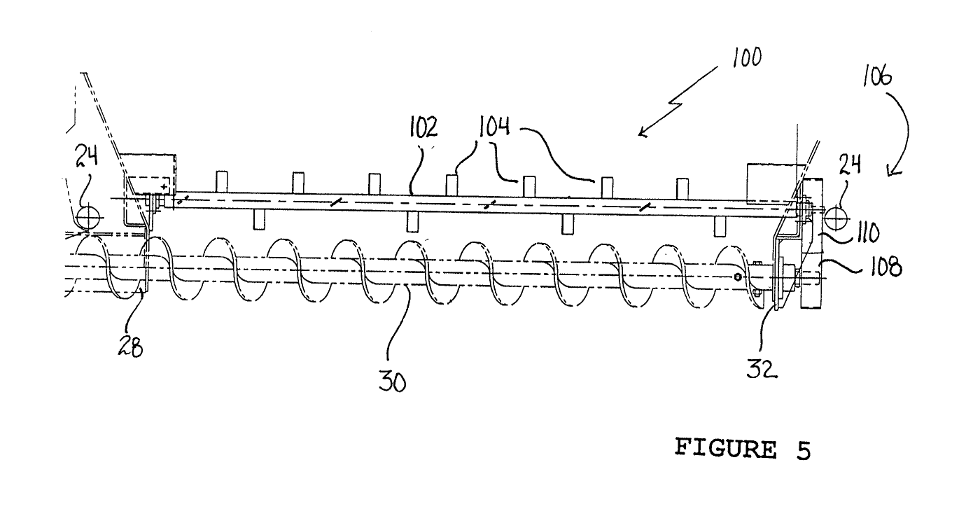

Referring to FIG. 5, a break-up assembly 100 was mounted in parallel spaced relation to auger 30. Break-up assembly 100 has a rotatably mounted shaft 102 with a plurality of radially extending paddles 104. As shaft 102 rotates, paddles 104 break up the material and feed the material onto auger 30. Shaft 102 is rotated by means of a drive assembly generally identified by reference numeral 106. Drive assembly 106 includes a sprocket 108 on auger 30 which engages a sprocket 110 on shaft 102. As auger 30 rotates the rotational movement of auger 30 is transmitted from sprocket 108 via sprocket 110 to shaft 102. While the gear ratio can be varied if desired, beneficial results have been obtained by sizing sprocket 108 and sprocket 110 to provide a one to one gear ratio so that for every one rotation of auger 30, shaft 102 of break-up assembly 100 also rotates one rotation.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

The Embodiments of the invention in which an exclusive property or privilege is claimed are defined as follows:

1. A belly dump vehicle, comprising:
a containment body with an exterior surface and an underlying belly having opposed ends;
ground engaging support wheels supporting the body spaced from the belly;
doors in the underlying belly which are moveable from a closed position to an open position;
a first prime mover for moving the doors from the closed position to the open position whereby a load of granular matter contained within the belly is dumped;
an auger tunnel extending through one of the opposed ends of the belly and communicating with the exterior surface of the body;
a rotatably mounted auger extending between the opposed ends of the belly and protruding into the auger tunnel;
a granular matter broadcast assembly mounted to the exterior of the body in communication with the auger tunnel; and
a second prime mover for selectively rotating the auger, whereby granular matter from a load contained in the belly is fed by the auger through the auger tunnel to the broadcast assembly.

2. The belly dump vehicle as defined in claim 1, wherein a shaft having a plurality of paddles is mounted in parallel spaced relation to the auger, such that as the shaft rotates the paddles feed material to the auger.

3. The belly dump vehicle as defined in claim 2, wherein the shaft is rotatably driven by a drive assembly which is coupled to the auger, such that rotation of the auger transmits a rotational force via the drive assembly to the shaft.
